(19) United States
(12) Patent Application Publication
(10) Pub. No.: US 2002/0116223 A1
(43) Pub. Date: Aug. 22, 2002

(54) System and method for selection of a primary care physician

(75) Inventors: Christopher J. Bonin, Greenfield, WI (US); Carolyn Maclver, Whitefish Bay, WI (US); Mary Fields, New Berlin, WI (US)

Correspondence Address: James A. Wilke, Foley & Lardner, Firstar Center, 777 East Wisconsin Avenue, Milwaukee, WI, 53202-5367, US

(73) Assignee: Aurora Health Care, Inc.

(21) Appl. No.: 10/078,803

(22) Filed: Feb. 19, 2002

Related U.S. Application Data
(60) Provisional application No. 60/270,024, filed on Feb. 20, 2001.

(51) Int. Cl. G06F 17/60

(52) U.S. Cl. 705/2

(57) ABSTRACT

A video visit method and system to facilitate the selection of a consumer of a primary care physician. The system comprising a medium configured to receive and play back audio and video data. A representation of the primary care physician depicted on the medium. And, a means for delivery of the medium to the consumer upon request.

### CROSS-REFERENCE TO RELATED PATENT APPLICATIONS

This application claims the benefit of U.S. Provisional Application 60/270,024, filed Feb. 20, 2001, the entire contents of which are hereby incorporated into the present application by this reference.

### BACKGROUND OF THE INVENTION

Other then in an emergency situation, consumers typically select the primary care physician they desire to attend to the consumers' medical needs. The health care consumers have a variety of resources they use in the selection of a primary care physician. For instance, aids in selecting a primary care physician can be a physician profile sheet which describes the physician's education and practice and style. A physician website profile is similar to the printed physician profile sheet except it is accessed electronically. The referral service which maintains a database of physicians is accessed by the consumer typically via telephone. An insurance provider directory which lists physician names and practice locations of physicians participating in the particular health insurance plan.

Studies have indicated that “bedside manner”, the bedside personality and interpersonal skills of a physician are deemed very important by a consumer when making their primary care physician choices. The above mentioned existing aids to a consumer in the selection of their primary care physician, to differing degrees, are useful, effective, accurate and convenient. However, none of those aids adequately fulfill the needs and desires of a consumer with respect to the knowledge about bedside manner, personality and interpersonal skills of the physician. One of the primary shortcomings of the existing aids is that none give the consumer any accurate idea of the physician's appearance, personality or interpersonal skills.

Thus, there is a need for a system and a method to facilitate the consumer selection of a service provider, such as, for example, a primary care physician. Further, there is a need for a system or method that will convey the physician's appearance, personality and interpersonal skills to support the consumer's choice of a primary care physician. Further, there is a need for system and method of providing a video medium to a consumer that will convey the particular physician's attributes, skills, abilities, medical specialty, personal interest areas, educational background and practice philosophy/medical treatment or style and the like to assist the consumer in selecting the primary care physician.

### SUMMARY OF THE INVENTION

The present invention provides a method of facilitating a consumer selection of a primary care physician. The method comprises selecting participating primary care physicians and preparing each physician for a video tape performance. Videotaping each physician and editing each videotape performance for length of time and content. Combining each videotape performance with each one of a selected ancillary clinic information and a provider information to form a video visit videotape. Developing advertising content and advertising medium describing the video visit videotape availability. Collecting and processing a consumer request for the video visit videotape in response to the advertising and, providing the video visit videotape to a consumer to fill the consumer request.

There is also provided a method for preparing a videotape suitable for facilitating a consumer selection of a primary care physician. The method comprising the steps of selecting a participating physician. Instructing the physician on consumer criteria for selecting the primary care physician and instructing the physician on performance criteria. Portraying the physician to convey attributes of the physician from a group consisting of personality, credentials, capabilities, bedside manner, medical interest area, hospital affiliation, clinic affiliation and education. Videotaping the physician and editing the videotape to convey the attributes of the physician to meet the consumer criteria. Combining the editing videotape with advertising material and configuring the videotape and advertising material for delivery to the consumer. Another embodiment of the method includes the steps of selecting at least one additional physician and combining the selected physicians for the videotape based on geographic location.

There is further provided a video visit system to facilitate the selection of a consumer of a primary care physician. The system comprising a medium configured to receive and play back audio and video data. A representation of the primary care physician depicted on the medium. And, a means for delivery of the medium to the consumer upon request.

It is additionally provided a video visit apparatus to facilitate the selection by a consumer of the primary care physician. The apparatus comprising a medium configured to receive and play back audio and video data and a representation of the primary care physician depicted on the medium.

There is further provided a video visit apparatus to facilitate the selection by a consumer of a service provider. The apparatus comprising a medium configured to receive and play back audio and video data and a representation of the service provider depicted on the medium.

### BRIEF DESCRIPTION OF THE DRAWINGS

FIG. 1 is a chart illustrating an exemplary embodiment of a system for facilitating a consumer selection of a primary care physician.

FIG. 2 is a schematic illustration of an exemplary embodiment of a video visit apparatus and system to facilitate the selection by a consumer of a service provider.

### DETAILED DESCRIPTION OF THE PREFERRED EMBODIMENTS

Before describing several exemplary embodiments of the system and method for a selection of a primary care physician, several comments are appropriate. Consumers have a variety of resources that they can use in the selection of a service provider. If a consumer is in need of an attorney, an accountant, an auto mechanic or the like, the consumer can obtain information about such service provider from various advertising sources such as newspapers, television commercials, or radio commercials. The consumer can also consult the Yellow Pages or other persons who have utilized certain service providers in the past. Today, the internet also provides an easy and ready access to information relating to service providers. All of these methods are approached from the consumer's point of view.

Applicants have approached the consumer's need from the provider's point of view in providing a method and system for acquiring new customers or consumers for the services that a provider offers. Specifically, applicants have provided exemplary embodiments of a system and method for acquiring new patients for primary care physicians within a health care system and its affiliated hospitals, clinics and ancillary heath care services.

Although the following exemplary embodiments are directed to the selection of primary care physicians, it is contemplated that the methodology, system, and apparatus disclosed herein can be modified with respect to content to be applicable to other service providers in other industries or professions.

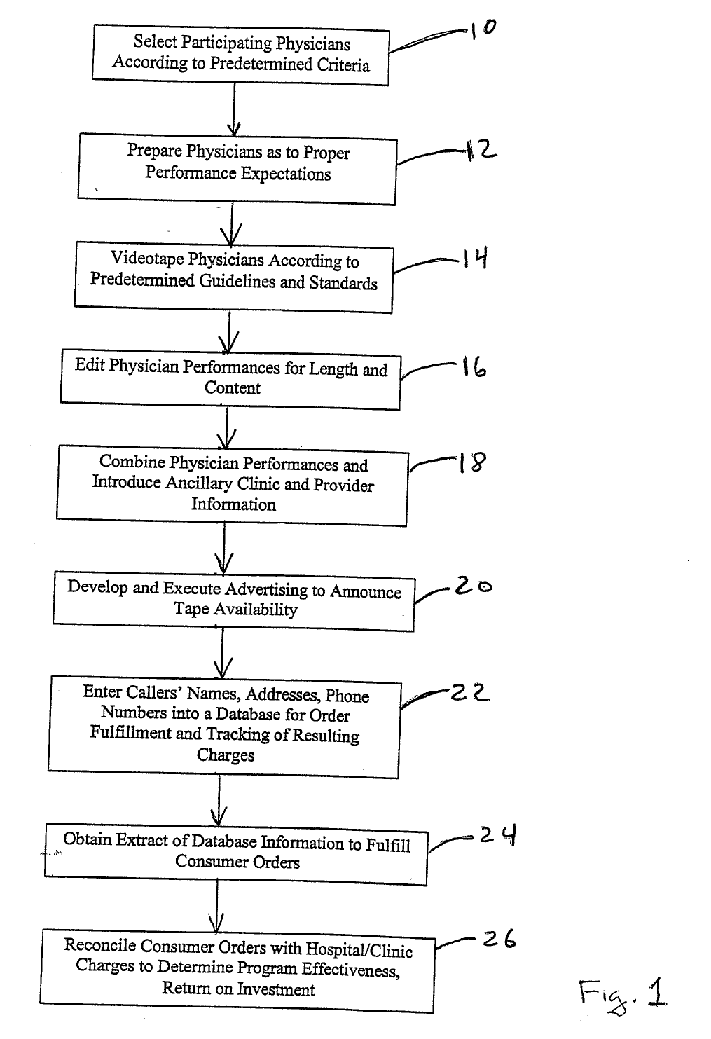

Referring now to FIG. 1, there is illustrated a chart of an exemplary embodiment of a system for facilitating a consumer selection of a primary care physician. The method comprises the selecting of participating primary care physicians according to a predetermined criteria 10. Such criteria includes but is not limited to identifying physician practice characteristics. It also includes the identifying of physician specialties such as a family practice, OB/GYN, internal medicine, pediatrics, and the like. Such criteria also includes the hospital affiliation of the particular physician. Typically, this hospital affiliation is with the same health care organization and the physician is typically a member of the staff of such organization.

The physician has to be prepared as to proper performance expectations 12 prior to the preparation of the media that will be utilized. An example of media is a videotape. Prior to the videotaping session of the physician or physicians the physicians are prepared. The physicians are informed of information that is deemed most important by consumers in selecting a primary care physician. The physicians are instructed governing their dress, general appearance and suggestions for delivery of their performance.

The purpose of the videotaping is to help prospective new patients learn more about a physician than what they can learn from reading the curricular vitae or one of the biographical sheets that are typically made available to patients concerning a primary care physician and/or the health care organization's facilities. The preparation includes suggesting questions that the physician may answer during the videotaping session with the objective of making the physician feel very casual and comfortable and not necessarily scripting the responses to the criteria questions.

Some typical preparation procedures include discussing the physician's involvement in his immediate community and suggesting dress such as wearing a lab coat, dress shirt and tie, and the like.

The setting in which the videotaping takes place can include showing the physician interacting with patients in a clinical setting to provide consumers a real sense of how their interaction would compare should they select a particular physician. Typically, audio data is not used along with the video data of patient/physician interaction during the videotaping session. However, appropriate audio data, such as by voice over or music, is edited onto the video data used on the selected media at a later time. An advantage to this process is that the physician does not have to deliver his or her performance from beginning to end without interruption and provides an opportunity to fuse separate physician soundbites together in a seamless manner. Also, update information can be added to the medium at any time without having to re-shoot the scenes.

The videotaping of the physician is done according to predetermined guidelines and standards 14. Portrayal of the physician by use of videotape to convey physician personalities, credentials, capabilities, bedside manner, interest areas, hospital affiliation, clinic affiliation, and education are used during this procedure. By maintaining the standardized approach, the consumer is provided with an opportunity to make respective comparisons between physicians and against each consumer's individualized selection criteria.

In addition to providing information about specific physicians, the physician's clinic's attributes can also be depicted. For instance, ancillary services or availability of specialty healthcare at a particular clinic as provided by the selected physician can also be depicted on the medium.

After the raw videotaping is completed, an edit of the physician performance for length and content is done 16. The purpose of the editing is to utilize selected portions of the physician's performance thereby revealing to a target consumer the most relevant information in a condensed format. The editing process includes audio data such as voice-over which provides location addresses of the clinics, or a list of the ancillary and specialty services provided at that particular clinic address and by the particular physician or physicians. It is also possible to provide audio and video data describing or depicting a clinic's visual, interior and exterior, characteristics 18.

With respect to the physician's performance, the physician's face is shown, the physician's name, medical specialty is then superimposed graphically on the medium. Excerpts from the physician's interview edited together into a two to three minute segment during which the physician conveys specialized training, medical schooling, special interest areas, practice philosophy, approach to care, clinical interest areas and the physician's family life, personal outside interests or any other such information that might be deemed pertinent and appropriate in assisting a consumer in selecting the primary care physician. Such editing combines the video performance with at least one of the selected ancillary clinic information and a provider information to form a video visit videotape 18.

It should be noted that although the exemplary embodiment being described herein is a videotape, it should be understood that the medium on which the video visit is placed can be a computer disk, a compact disk, a data stream transmitted over land lines, fiber optics, microwave transmissions, or other suitable and appropriate electromagnetic spectrum.

The method of facilitating a consumer selection of a primary care physician also includes then developing advertising content and advertising medium describing the video visit videotape's availability 20. The healthcare organization typically will use newspaper ads, radio ads and direct mail to inform consumers of the video visit videotape availability. The departure from the prior art methods of advertising is that in this case, it is the video visit medium that is being advertised as being available rather than the specific content of such video visit medium.

Such advertising can be developed internally by the health care organization or a third party advertising service provider can be utilized.

After the advertising is provided to the general public, consumers who have read or seen or heard such advertising will contact the healthcare organization to request a copy of a video visit videotape. The collecting and processing of a consumer request for video visit videotapes in response to the advertising is then done. Such process includes the entering of caller's names, addresses, phone numbers and the like into a database for order fulfillment and tracking of resulting charges 22. Such information is collected on a daily basis either by the healthcare organization or by a third party order fulfillment organization. If the consumer makes a telephone call to obtain a copy of the video visit videotape, the callers are asked where they heard about the offer and this information is entered into a database to track the most productive advertising mediums. Such process obtains an abstract of database information to fulfill consumer orders 24.

The video visit videotape is then provided to a consumer to fulfill the consumer's request. There is a reconciliation of the consumer orders with the hospital/clinic and physician charges to determine the program effectiveness and the return on investment 26 for future reference.

With respect to the reconciliation of the consumer orders, with the hospital clinic charges to determine program effectiveness and return on investment 26, a set of rules is established for determining the value of the new business generated by the video visit medium. The goal of these rules is for determining a return on investment based on at least a cost to produce the video visit videotape and a cost charged to the consumer by the physician selected by the consumer. Applicants have determined that there are at least three types of encounters that are financially positive for the physician and healthcare organization. They are:

1. Encounters with a physician featured on the medium deemed a “video referral.” The encounter must be between a member of a consumer household and the physician featured on the video visit medium sent to the household. The household consumer must not have had an encounter with that particular physician before the date they received the medium. The first encounter must be within twelve months of receiving the medium and the last encounter that will be attributed to the particular medium will be no more than twelve months after the first encounter. There may be a time delay from when the consumer requested a copy of the video visit medium and when the consumer actually receives that medium depending on the method of delivery as will be explained below.

2. Encounters with physicians referred verbally and designated a “video bio-line phone referral.” The encounter must be between a member of a consumer household and a physician referred to the household by a teleservices video bio-phone line. The household member must not have had an encounter with that physician before the date the household was given the referral and the first encounter must be within three months of receiving the referral and the last encounter that will be attributed will be no more than twelve months after the first encounter.

3. Encounters with other physicians after first encounter with a referring physician designating “supplemental referrals.” The encounter must be between a member of a consumer household that was referred to a physician by a physician video visit medium or by teleservices video bio-phone line and a physician that was not presented to the household. The household member must not have had an encounter with that physician until after they have had either of the two types of encounters described above (Encounter 1 or 2 above). The first encounter must be within twelve months after the consumer's earliest encounter with a physician referred to via a physician video visit medium or by teleservices video bio-phone line. If a consumer household receives more than one referral to the same physician by either a video visit medium or a phone referral, it will be considered that the household received only one referral on the date they received the first referral and will categorize the referral by the medium used to deliver that first referral.

An analysis of the above described referrals, will disclose detail of the total encounters, the patients (consumers) and charges with subtotals for video visit medium referrals, video bio-phone line referrals and supplemental referrals. A match is then conducted with resulting provider charges to project costs determined for the year and if there is a cost effectiveness of a particular methodology.

A video visit medium can also be edited to combine selected physicians for a given video visit medium or video visit videotape based on geographic location of either the physicians or the clinic facilities at which the physicians provide their services.

The method and system for the selection of a primary care physician can also include additional advertising material that is combined with video visit medium. Such advertising material can include photographs, printed brochures, supplemental descriptions of physical facilities, equipment utilized at such facilities and excerpts of accolades given for the physicians or the health care organization with which the physicians are affiliated.

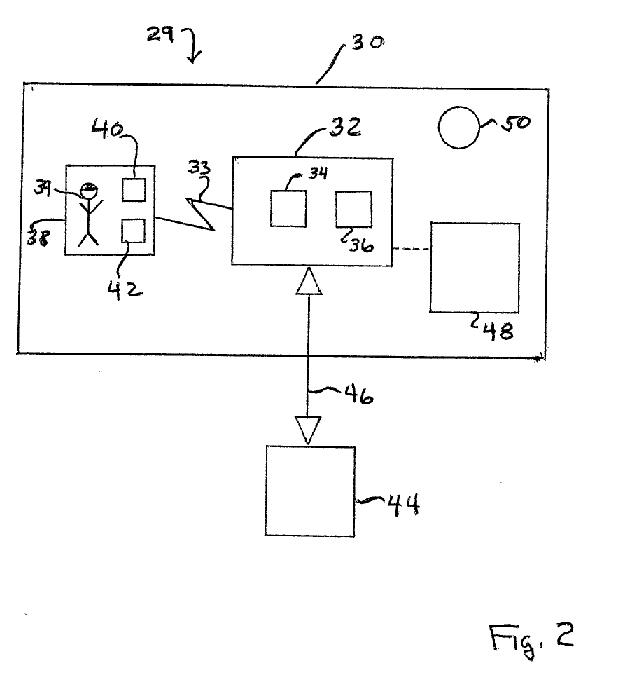

Referring now to FIG. 2, there is depicted a video visit system 29 to facilitate the selection by a consumer 44 of a primary care physician 39. The video visit system 29 comprises a medium 32 configured to receive and play back audio data 36 and video data 34. A representation 38 of the primary care physician 39 is depicted on the medium 32. A means for delivery 46 of the medium to the consumer 44 upon request by the consumer is also provided.

The medium 32 can be any suitable and convenient device or methodology. For example, the medium 32 can be the magnetic videotape that can receive and play back video and audio data such as a VHS format tape, it can be a computer disk such as a floppy disk or a hard drive disk storage device. The medium 32 can also be a compact disk or DVD disk.

The means for delivery 46 of the medium 32 to a consumer 44 upon the request of the consumer 44 can be any suitable methodology. For example, the means for delivery 46 can be regular U.S. Mail, using a self-mailing outer box configured for holding the medium 32 and any printed literature that accompanies the medium 32. It can be delivered by a courier such as provided by Federal Express Corporation or United Parcel Service. It can be provided by a stream of data over the internet, by microwave transmission, by wire or optical guides.

In addition to the representation 38 of the primary care physician 39, the video visit system 29 can also include clinical information 40 and provider information 42. Such information as described above can be in the nature of video or audio data 34, 36 or printed literature or a combination of such information.

It is also contemplated that a plurality of primary care physicians 39 can be depicted on the medium 32. Such plurality of primary care physicians 39 can be a practice group or a particular clinic staff or other convenient and suitable grouping of physicians. A particularly useful grouping is a plurality of primary care physicians 39 selected on the basis of geographic location. The geographic location can be based on the location of the clinic or hospital affiliation of the plurality of primary care physicians 39 or it can be the geographic area in which the physicians provide their service in conjunction with several clinic facilities or hospitals.

The video visit system 29 can also include advertising medium 48 which describes the availability of the system 29. Such advertising medium 48 can include but is not limited to the radio, newspaper, printed advertising, direct mail, printed flyers hung on a consumer's door on certain markets, televised phone banks, promotion during employer open enrollment fairs, promotions within the healthcare organization's urgent care centers, media stories and websites maintained by a specific clinic or hospital, or the healthcare organization itself, or by individual physicians or practice groups.

The video visit system 29 can also include a means for tracking 50 for use of the video visit system 29. Such means for tracking 50 can include recording consumers 44 that call or request a copy of the medium 32 in obtaining the consumer's name, address, phone numbers and matching these at a later date to clinic and hospital databases to determine if the consumer came to such facilities and utilized a primary care physician 29 depicted in the video visit system 29. Other means of tracking 50 can include the use of barcodes on the medium 32 itself, mailing or courier records and such other suitable and like methodologies.

FIG. 2 also illustrates a video visit apparatus 30 which is used to facilitate the selection by a consumer 44 of a primary care physician 39. The apparatus 30 comprises a medium 32 configured to receive and playback audio data 36 and video data 34 and includes a representation 38 of the primary care physician 39 depicted on the medium 32. A means for transferring data 33 of the representation of the physician 38, clinic information 40 and provider information 42 can be done typically with a digital camera or a conventional video camera. The information can also be transmitted with the microphone either by radio transmission or hardwired to a recording device. Such data can also be inputted using a keyboard and/or computer mouse.

As described above, the video visit apparatus 30 can also be used to facilitate the selection by a consumer 44 of a service provider other than a physician. The service provider can be an engineer, a lawyer, an accountant or the like.

Thus, there is provided a system and method for the selection of a service provider such as a primary care physician. While the embodiments illustrated in the figures and described above are presently preferred, it should be understood that these embodiments are offered by way of example only. The invention is not intended to be limited to any particular embodiment but is intended to extend to various modifications that nevertheless fall within the scope of the appended claims. For example, the video visit medium can be edited to add or delete information, in a voice-over procedure that will configure the video visit medium to accommodate changes in the physician's or service provider's education and experience or in the capabilities of a particular clinic or hospital or service facility that is depicted on the video visit medium. It is also contemplated that the video visit system and apparatus can be configured to be used with other devices such as a personal digital assistant and a portable personal computer. Additional modifications will be evident to those with ordinary skill in the art.

What is claimed is:

1. A method of facilitating a consumer selection of a primary care physician, the method comprising:
selecting participating primary care physicians;
preparing each physician for a videotape performance;
videotaping each physician;
editing each videotape performance for length of time and content;
combining each videotape performance with at least one of a selected ancillary clinic information and a provider information to form a video visit videotape;
developing advertising content and advertising medium describing the video visit videotape availability;
collecting and processing a consumer request for the video visit videotape in response to the advertising; and,
providing the video visit videotape to a consumer to fill the consumer request.

2. The method of claim 1, including the step of reporting the relationship between the consumer request and the physician selected by the consumer.

3. The method of claim 2, including the step of reconciling the consumer request with the physician selected by the consumer and determining a return on investment based on at least a cost to produce the video visit videotape and a cost charged to the consumer by the physician selected by the consumer.

4. The method of claim 1, including the step of combining selected physicians for the video visit videotape based on geographic location.

5. A method for preparing a videotape suitable for facilitating a consumer selection of a primary care physician, the method comprising the steps of:
selecting a participating physician;
instructing the physician on consumer criteria for selecting the primary care physician;
instructing the physician on performance criteria;
portraying the physician to convey attributes of the physician from a group consisting of personality, credentials, capabilities, bedside manner, medical interest area, hospital affiliation, clinic affiliation and education;
videotaping the physician;
editing the videotape to convey the attributes of the physician that meet the consumer criteria;
combining the edited videotape with advertising material; and,
configuring the videotape and advertising material for delivery to the consumer.

6. The method of claim 5, including the step of selecting at least one additional physician.

7. The method of claim 6, including the step of combining selected physicians for the videotape based on geographic location.

8. The method of claim 6, including the step of delivering the videotape and advertising material to the consumer.

9. The method of claim 5, including the step of reporting the relationship between the delivered videotape and the physician selected by the consumer.

10. The method of claim 5, wherein the advertising material includes developing an advertising medium describing the videotape availability.

11. A video visit system to facilitate the selection by a consumer of a primary care physician, the system comprising:
a medium configured to receive and playback audio and video data;
a representation of the primary care physician depicted on the medium; and,
a means for delivery of the medium to the consumer upon request.

12. The video visit system of claim 11, wherein the representation includes clinic information and provider information.

13. The video visit system of claim 1 1, wherein a plurality of primary care physicians are depicted on the medium.

14. The video visit system of claim 1 3, wherein the plurality of primary care physicians are selected on the basis of geographic location.

15. The video visit system of claim 11, including advertising medium describing the availability of the system.

16. The video visit system of claim 11, including a means for tracking the use of the video visit system.

17. A video visit apparatus to facilitate the selection by a consumer of a primary care physician, the apparatus comprising:
a medium configured to receive and playback audio and video data; and,
a representation of the primary care physician depicted on the medium.

18. The video visit apparatus of claim 17, wherein the representation includes clinic information and provider information.

19. The video visit apparatus of claim 17, wherein a plurality of primary care physicians are depicted on the medium.

20. The video visit apparatus of claim 19, wherein the plurality of primary care physicians are selected on the basis of geographic location.

21. The video visit apparatus of claim 17, including advertising medium describing the availability of the apparatus.

22. The video visit apparatus of claim 17, including a means for delivery of the medium to the consumer upon request.

23. The video visit apparatus of claim 17, including a means for tracking the use of the video visit apparatus.

24. A video visit apparatus to facilitate the selection by a consumer of a service provider, the apparatus comprising:
a medium configured to receive and playback audio and video data; and,
a representation of the service provider depicted on the medium.

25. The video visit apparatus of claim 24, wherein the representation includes service provider information.

26. The video visit apparatus of claim 24, wherein a plurality of service providers are depicted on the medium.

27. The video visit apparatus of claim 26, wherein the plurality of service providers are selected on the basis of geographic location.

28. The video visit apparatus of claim 24, including advertising medium describing the availability of the apparatus.

29. The video visit apparatus of claim 24, including a means for delivery of the medium to the consumer upon request.

30. The video visit apparatus of claim 24, including a means for tracking the use of the video visit apparatus.
